(19) United States
(12) Patent Application Publication
(10) Pub. No.: US 2006/0127744 A1
(43) Pub. Date: Jun. 15, 2006

(54) Separator for fuel cell and fuel cell using it

(76) Inventors: Kenji Yamaga, Hitachi (JP); Hiroshi Yamauchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/302,172

(22) Filed: Dec. 14, 2005

(30) Foreign Application Priority Data
Dec. 15, 2004 (JP) 2004-362343

(51) Int. Cl. H01M 8/02; H01M 2/08

(52) U.S. Cl. 429/38; 429/35

(57) ABSTRACT

The present invention provides a separator for a fuel cell constructed using a metallic pressed plate, in which a gas channel from a manifold to an electrode surface is formed simply, and a good sealing characteristic is realized. The separator is comprised of a metallic pressed plate, a resinous frame member, and a sealing frame having a sealing material integrated therewith, and a channel for introducing a gas from the manifold to an electrode surface is formed by a metallic surface, the sealing material and a resinous surface. An elastomer such as a rubber is used for the sealing material. Thus, the gas channel from the manifold to the electrode surface can be formed simply, and an excellent sealing characteristic to the gas and water is obtained.

### BACKGROUND OF THE INVENTION

1. Field of the Invention

The present invention relates to a fuel cell for taking out an electric energy directly from a fuel and an oxidizing agent by utilizing an electrochemical reaction, and particularly, to a separator.

2. Description of Related Art

A solid polymer fuel cell using a solid polymer ion-exchange membrane, e.g., a proton-conductive polymer film for an electrolyte is a power-generating system which is currently at a phase of the research and development, but one of subjects aimed at the practical use is that the material cost is higher. One of costly materials is a separator, also known as a bipolar plate. The separator is a designation for an electron-conductive plate provided with a gas channel and adapted to isolate two types of reaction gases so as to prevent them from being mixed with each other. When the fuel cell is generating a power, the internal environment is corrosive and hence, it is desired that the separator has a higher corrosion resistance. It is further desired that a material for the separator has properties such as a higher mechanical strength, a gas-impermeability and a lower resistance.

A dense graphite plate, a resin molded graphite comprising graphite particles coagulated by a resin or the like is currently used as a material for the separator, and the separator is produced by forming a gas channel in such a material. A material which has a possibility of reduction in cost of the separator is a metal material. In general, the metal material can be thinned because of its higher strength, and is also excellent in processability and hence, it is possible to remarkably reduce the material cost and the processing cost per separator. In a case of a metal separator, however, there is a fear that a corrosive material may be produced under a power-generating environment of the fuel cell. In this regard, a metallic separator having a corrosion resistance enhanced by forming a special material on a surface or by applying a conductive protecting paste to a surface is being developed.

In a case of a carbon separator, it has a thickness on the order of 2 mm or more and hence, a gas channel can be formed on a surface and a back of the separator, but the shape of the gas channel press-worked in the surface of the metal plate is reflected to the back of the plate and as a result, an unevenness of the gas channel can be made on the surface and the back of the plate. In a case where a separator is formed by combination of a plurality of metallic plates, the shapes of gas channels in a surface and a back are independent from each other, but the cost is increased.

It is most inexpensive to produce a separator by processing a single metallic plate. In this case, a gas channel is formed utilizing a surface and a back of the plate and hence, the channel is formed only in a common portion of the surface and the back. For example, if an introduction channel portion for introducing a gas from a manifold to an electrode surface is formed in a metallic plate by a pressing according to this method, the gas from the manifold flows to both of the surface and the back of the single separator and for this reason, it is impossible to generate a power. Therefore, it is difficult to form, in the metallic plate, a channel which connects the manifold and the electrode surface to each other. In this case, it is necessary to form a gas channel in another material.

One of such materials is a resinous frame member. The resinous frame member is a plate having a manifold and a bore made in a portion for an electrode. If a gas channel for introducing a gas from the manifold to an electrode portion is formed in the resinous frame member and a metallic pressed plate and the resinous frame member are integrally bonded to each other by an adhesion or the like, a separator capable of being used in a fuel cell can be produced. The gas channel is a space for permitting the flowing of the gas therethrough, but it is necessary to provide a structure in which the deformation, the crush or the like of the channel is difficult to occur by a clamping pressure applied to the cell. In general, a slit structure is employed which is provided with a structural member having a channel of a decreased width and capable of receiving a clamping pressure. A method for forming a slit-shaped gas channel includes, for example, a cutting process. The formation of the gas channel by the cutting is excellent in respect of the accuracy, but is accompanied by problems in respect of the processing cost and time. A method for integrally bonding a resinous frame member and a metallic pressed plate to each other, for example, by adhesion using an adhesive, is also accompanied by problems in respect of the time and the sealability.

In order to avoid these problems, there is a proposed process which comprises integrally forming a metallic pressed plate and a frame using an injection molding of a resin, and drawing them using a core for forming a channel in the molding, thereby ensuring a space serving as a gas channel (for example, see JP-A-2002-75396).

In the process which comprises integrally forming the metallic pressed plate and the frame using the injection molding of a resin, and ensuring the space serving as the gas channel using the core for forming the channel, a large-scaled producing apparatus is required.

It is an object of the present invention to ensure that in constituting a separator by a metallic pressed plate and a resinous frame member, the formation of a gas channel for introducing a gas from a manifold to an electrode surface can be achieved without recourse to a machining or an injection molding.

### SUMMARY OF THE INVENTION

The present invention provides a separator for a fuel cell, which comprises a metallic pressed plate, a resinous frame member, and a sealing frame having a sealing material integrated therewith, a gas channel for introducing a gas from a manifold to an electrode surface being formed by the metallic pressed plate, the sealing material and the resinous frame member.

The present invention also provides a fuel cell having a structure in which an anode and a cathode are piled on opposite sides of an electrolyte membrane formed of a polymer ion-exchange membrane, respectively, and the resulting assembly is sandwiched from opposite sides by separators, wherein the separator is formed in the just-described arrangement.

The separator according to the present invention can exhibit an excellent sealing characteristic to a gas and water, because the resinous frame member and the sealing material are formed integrally with each other. In addition, the sealing material itself functions as a structure forming the gas channel and hence, the channel for introducing the gas from the manifold to the electrode can be made without recourse to a machining or an injection molding.

In the separator according to the present invention, it is desirable that the metallic pressed plate is formed of titanium or a stainless steel, or at least a surface layer of the metallic pressed plate is formed of titanium or a stainless steel. The inside of the fuel cell during generation of a power is in a corrosive atmosphere, and when a metal is used as a material for forming the cell, the metal is required to have a high corrosion resistance. If, for example, a carbon steel having a low corrosion resistance is used, it is immediately corroded, whereby iron ion is eluted. The iron ion entrapped into an electrolyte material to cause an ion-exchange, resulting in a reduction in ionic conductance. As a result, the performance of the cell is degraded, and the deterioration of the cell is advanced. Therefore, if a metal material is used in the cell, then it is essential that such metal material has a high corrosion resistance, and if the material cost is taken into consideration, it is preferable that a surface portion is formed of titanium or a stainless steel.

According to the present invention, it is also preferable that the sealing material integrated with the resinous frame member is formed of an elastomer such as a rubber, and further, it is preferable that the sealing material has different heights from a resin surface within the same sealing frame. If the sealing rubber has the same height, the sealing between the sealing rubber and the metallic pressed plate upon the combination of them is the sealing provided by their surfaces, i.e., a so-called surface-sealing. However, if the height of the sealing rubber is varied within the same sealing frame, a so-called line-sealing structure can be realized, which can accommodate an increase in pressure of a reaction gas.

It is also desirable that the sealing rubber integrated with the resinous frame member is formed on both of the surface and the back of the resinous frame member. The sealing frame is disposed between the metallic pressed plate and the electrolyte membrane, and the sealing rubber is a structure which is in close contact with the metallic pressed plate. However, the sealing between the electrolyte membrane and the sealing frame is a surface sealing, and there is a possibility that a sufficient sealing characteristic is not necessarily obtained, due to the utilization of the elasticity of the electrolyte membrane. It is possible to accommodate an increase in pressure of the reaction gas supplied to the cell by forming the sealing material even on the side of the sealing frame adjacent the electrolyte membrane.

Further, it is desirable that the sealing material is formed of at least two types of elastomers different in hardness. In the sealing frame, the sealing material integrated with the resinous frame member functions as a structure which seals the reaction gas and cooling water and forms the gas channel. If the structure forming the gas channel is deformed by a clamping pressure required by the cell, the gas flowing through the channel is disturbed to causes an influence to the performance of the cell. If the portion functioning as the sealing material is not crashed moderately by the clamping pressure for the cell, a good sealing characteristic is not obtained. The sealability can be enhanced by ensuring that the sealing rubber is different in rubber hardness within the same sealing frame.

Other objects, features and advantages of the invention will become apparent from the following description of the embodiments of the invention taken in conjunction with the accompanying drawings.

### BRIEF DESCRIPTION OF THE DRAWINGS

FIG. 1 is a plan view of a sealing frame used in an embodiment 1 of the present invention;

FIG. 2A is a plan view of a sealing frame used in an embodiment 3 of the present invention;

FIG. 2B is a sectional view of the sealing frame used in an embodiment 3 of the present invention;

FIG. 3A is a plan view of a sealing frame used in an embodiment 4 of the present invention;

FIG. 3B is a sectional view of the sealing frame used in the embodiment 4 of the present invention;

FIG. 4A is a plan view of a frame made by cutting and used in Comparative Example 1;

FIG. 4B is a sectional view of the frame made by cutting and used in Comparative Example 1; and

FIG. 5 is a view showing a laminated arrangement of a cell made using the sealing frame according to the present invention.

### DETAILED DESCRIPTION OF THE INVENTION

Embodiments of the present invention will now be described, but the present invention is not limited to the following embodiments.

### EMBODIMENT 1

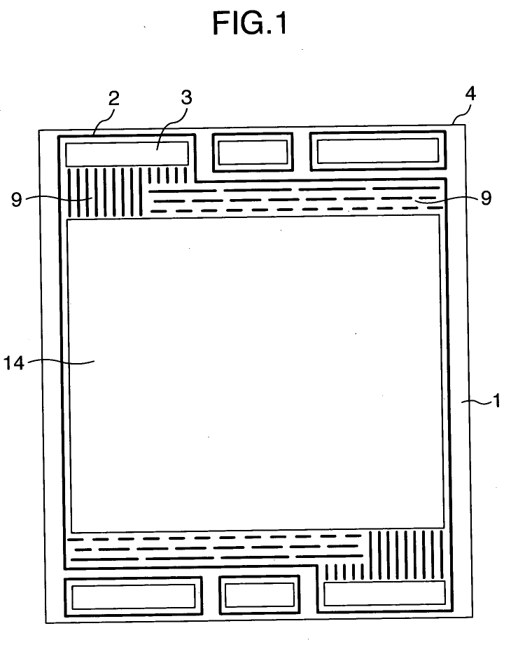

A varnish of an ethylene propylene diene monomer rubber (EPDM) was formed by a screen printing process on a resinous frame member 1 formed of a plate of polyphenylene sulfide (PPS) which was formed by a punching into a predetermined contour with a manifold 3 and a bore made for an electrode surface and which had a thickness of 0.2 mm. Then, the varnish was baked at a temperature of 150° C. in an air atmosphere to form a sealing material 2. The sealing material 2 forms a sidewall portion of a gas channel 9 for introducing a gas required for an electrochemical reaction from the manifold 3 to an electrode surface of a fuel cell. A sealing frame 4 is formed by the resinous frame member 1 and the sealing material 2. FIG. 1 is a plan view of the sealing frame. Reference numeral 14 in Figures denotes a perforation opened in the electrode surface. The sealing material has a height of 0.25 mm as formed, and EPDM has a rubber hardness of 60 degree. The rubber hardness is a value based on a durometer type A according to an IS07619 standard and so forth.

On the other hand, a metallic pressed plate having a channel formed therein by a pressing process to permit the flowing of the gas required for the electrochemical reaction was produced using a stainless steel (SUS316) having a thickness of 0.2 mm. The metallic pressed plate and the sealing frame 4 were combined with each other to provide a separator in the embodiment 1.

### EMBODIMENT 2

A separator in the embodiment 2 was produced in the same manner as in the embodiment 1, except that titanium was clad on opposite surfaces of a stainless steel (SUS316) to form a metallic pressed plate having a three-layer structure and a thickness of 0.2 mm.

### EMBODIMENT 3

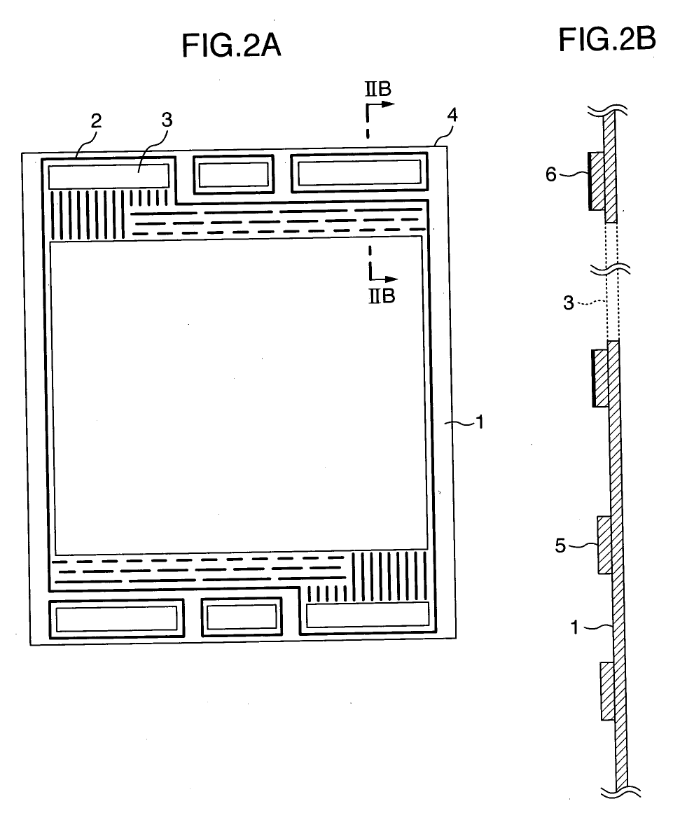

A separator in the embodiment 3 was produced using the same metallic pressed plate as in the embodiment 2 and using a sealing frame-producing process different from that in the embodiment 1. The sealing frame-producing process is as follows: An EPDM varnish was formed by a screen printing process on a PPS plate formed at a thickness of 0.2 mm into a predetermined contour by a punching, and then baked at 150° C. in an air atmosphere. Thereafter, a second printing was conducted with the screen plate replaced by new one, and the baking at 150° C. in an air atmosphere was conducted again. A plan view of a sealing frame produced is shown in FIG. 2A, and a sectional view taken along a line IIB-IIB in FIG. 2A is shown in FIG. 2B. A sealing material 2 has a height of 0.23 mm at a portion 5 formed by the first printing, and a height of 0.26 mm at a portion 6 formed by the second printing, because the portion 6 was piled on the portion formed by the first printing. The sealing frame has a rubber hardness of 60 degree.

### EMBODIMENT 4

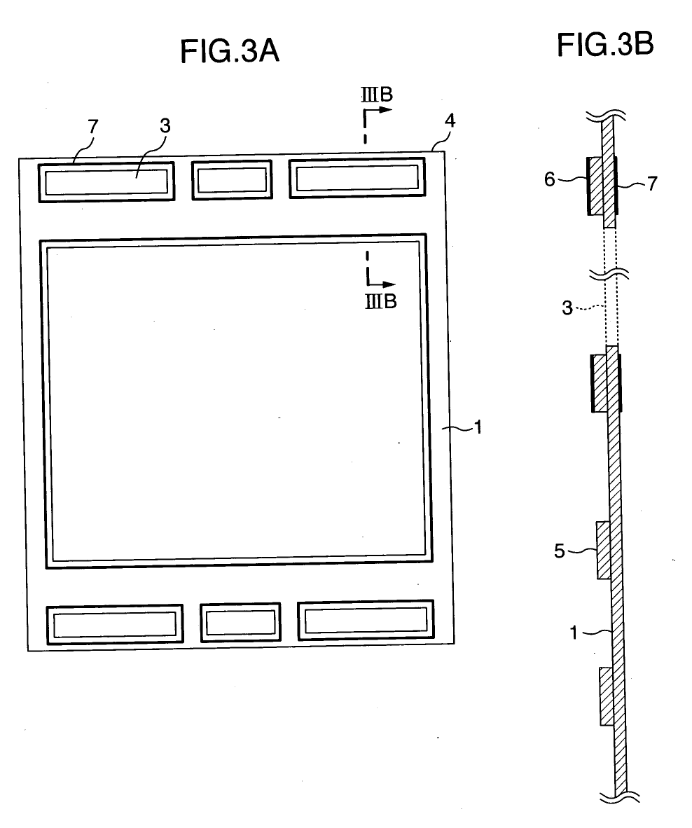

A sealing material was formed by a third screen printing on a surface of the sealing frame formed in the embodiment 3 with no sealing rubber formed thereon, and then baked at a temperature of 150° C. in an air atmosphere. A plan view of the sealing frame provided is shown in FIG. 3A, and a sectional view taken along a line IIIB-IIIB in FIG. 3A is shown in FIG. 3B. The sealing material 7 formed by the third printing has a height of 0.05 mm. The sealing frame had a rubber hardness of 60 degree. A separator in the embodiment 4 was produced by this sealing frame and a metallic pressed plate having a three-layer structure as used in the embodiment 3.

### EMBODIMENT 5

An EPDM varnish was formed by a screen printing process on a resinous frame member made of a PPS plate formed at a thickness into a predetermined contour by a punching and was then baked at a temperature of 150° C. in an air atmosphere. Further, a second printing was conducted with the screen plate and the EPDM varnish replaced by new ones, and the baking at 150° C. in an air atmosphere was conducted again. A sealing rubber had a thickness of 0.23 at a portion formed by the first printing on the sealing frame, and a thickness of 0.26 mm at a portion formed by the second printing, because it was piled on the portion formed by the first printing. The sealing material had a rubber hardness of 60 degree at the portion formed by the first printing and a rubber hardness of 70 degree at the portion formed by the second printing. The sealing material was combined with a titanium-clad metallic pressed plate having the same three-layer structure as that used in the embodiment 3 to produce a separator in the embodiment 5.

### COMPARATIVE EXAMPLE 1

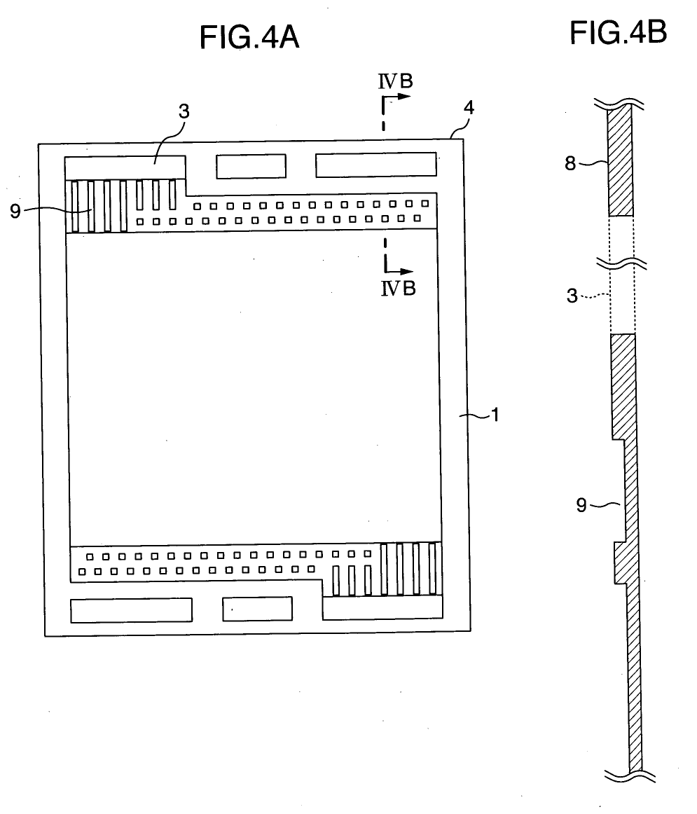

A separator was produced with no sealing material used. A manifold 3 for permitting the flowing of a reaction gas and cooling water was formed in a resinous frame member 8 made of a PPS plate having a thickness of 0.5 mm, and a gas channel 9 for introducing and discharging a gas to and from an electrode surface through the manifold was made by a cutting. A plan view of the resinous frame member 8 is shown in FIG. 4A, and a sectional view taken along a line IVB-IVB in FIG. 4A is shown in FIG. 4B. A clad material having the same three-layer structure as that used in the embodiment 2 was used as a metallic pressed plate. The resinous frame member 8 and the metallic pressed plate were bonded to each other by an adhesive (a liquid gasket made under a name of 1104 by Three Bond, Co.) and left to stand at 50° C. for 48 hours or more under the application of a pressure equal to or higher than 0.5 MPa. In this manner, a separator in Comparative Example 1 was produced.

### COMPARATIVE EXAMPLE 2

A metallic pressed plate having a channel formed therein by a pressing for permitting the flowing of a gas required for an electrochemical reaction was produced using a carbon steel (SS41) having a thickness of 0.2 mm. The metallic pressed plate was combined with the resinous frame member made by the process used in Comparative Example 1 to produce a separator in Comparative Example 1.

### EXPERIMENTAL PROCESSES AND RESULTS

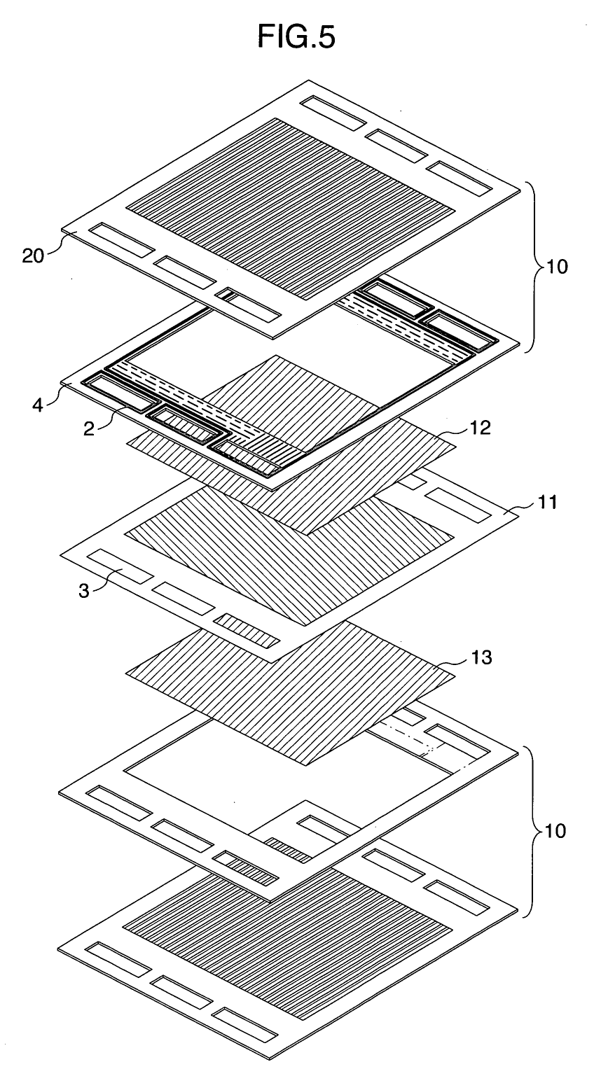

A simplex cell was assembled using the separator made by the process in each of the embodiments 1 to 5 and Comparative Example 1 and Comparative Example 2. A process for assembling the simplex cell will be described taking the separator made in the embodiment 1 as an example. An arrangement on the lamination of the simplex cell is as shown in FIG. 5. The separator 10 is comprised of a sealing frame 4 and a metallic pressed plate 20. A membrane electrode assembly 11 is formed by bonding an anode to one of surfaces of an electrolyte membrane, and bonding a cathode to the other surface, and a cathode diffusion layer 12 is laminated onto the surface of the membrane electrode assembly 11 having the cathode formed thereon. The cathode diffusion layer 12 is formed of a carbon paper having a polytetrafluoroethylene (PTFE) dispersed on its surface to provide a controlled water-repellency. An anode diffusion layer 13 is laminated onto the surface of the membrane electrode assembly 11 having the anode formed thereon. The anode diffusion later 13 is formed in the same manner as is the cathode diffusion layer. The separators 10 are laminated onto the cathode diffusion layer and the anode diffusion layer, respectively, and a cooling separator (not shown) is laminated onto each of such separators. The resulting structure is bolted to an end plate, thus completing the assembling of the simplex cell.

A power-generating test was carried out by supplying a modified test gas having a hydrogen concentration of 50% by volume as an anode gas and air as a cathode gas to the simplex cell made using each of the separators made the embodiment 1, the embodiment 2, Comparative Example 1 and Comparative Example 2 in such a manner that they were passed through a bubbler having a temperature of 60° C. to add a predetermined amount of water vapor. A power generation test was performed by flowing an electric current set at the electric current density of 0.3 A/cm² in an electronic loading device. In this case, an amount of gas consumed for the power generation based on an amount of gas supplied was defined as a utilization rate. The hydrogen utilization rate was set at 0.8, while the oxygen utilization rate was set at 0.5, and corresponding amounts of the gases were supplied. An amount of water equal to about 0.1 L/min controllable to any temperature was supplied to the cooled cell, whereby the temperature of the simplex cell was controlled in a range of 70 to 73° C., so that a power could be generated. The temperature of the simplex cell was measured using a cell temperature measuring port provided separately, wherein the temperature of a central portion of the electrode in the power-generating separator was measured. The test was continued until the lapse of 2,000 hours for each of the cells, and a variation in voltage of the cell was recorded. A rate of drop in voltage of the cell for the second half 1000 hours was compared among the cells.

Rates of deterioration of the cells made using the separators produced in the embodiment 1, the embodiment 2, Comparative Example 1 and Comparative Example 2 are shown as in Table 1 for comparison. The cell made using the separator produced in Comparative Example 2 had a deterioration rate of −300 mV/1000 hrs, while the cell made using the separator produced in the embodiment 1 had a deterioration rate of −10 mV/1000 hrs. This is because in the case of Comparative Example 2, the carbon steel of the metallic pressed plate was corroded under an environment of power generation of the cell, whereby iron ion was eluted and entrapped into the electrolyte, resulting in a reduction in ionic conductance, while the metallic pressed plate in the embodiment 1 had a good corrosion resistance and hence, an amount of eluted was relatively small, which means that a reduction in ionic conductance of the electrolyte could be suppressed. Further, in the embodiment 2, because the surface of the separator was formed of titanium excellent in corrosion resistance, the electrolyte was little deteriorated, and the voltage of the cell could be maintained.

The rates of reduction in voltage of the cells in the embodiment 2 and Comparative Example 1 assumed the same value of −2 mV/1000 hrs. This is because the same material was used for the metallic pressed plates in both of the embodiment 2 and Comparative Example 1, and it can be determined that the sealing frame made in the embodiment 2 has a function equivalent to that of the frame made through the cutting in Comparative Example 1.

TABLE 1

| | Rate of deterioration in |
|---|---|
| | voltage (mV/1000 hrs) |
| Embodiment 1 | −10 |
| Embodiment 2 | −2 |
| Comparative Example 1 | −2 |
| Comparative Example 2 | −300 |

The sealing pressures in the simplex cells made using the separators produced in the embodiment 2, the embodiment 3, the embodiment 4, Comparative Example 1 and Comparative Example 2 were examined. A pressure gage was mounted in a cell inlet in a gas supply line, and valves were mounted in the inlet and an outlet of the gas supply line, respectively. In a state in which the valve in the outlet was closed, nitrogen was gradually supplied to the cell, and after a predetermined pressure was reached, the valve in the inlet was closed. In this manner, a speed of drop in pressure was measured. The measurement was conducted for 30 minutes, and when a difference in pressure before and after the measurement was lower than 5%, the preset pressure was raised to 25 kPa for repetition of the similar measurement. It was regarded as the sealing characteristic of the cell that the leakage occurred at the preset pressure, when the difference in pressure became equal to or higher than 5%.

Results of evaluation of the sealing characteristics are given in Table 2. The maximum sealing pressure in Example 2 was 200 kPa (in terms of a gage pressure), whereas no leakage occurred up to 350 kPa in the embodiment 3. This is because the sealing material formed in the embodiment 2 was planar in shape, whereas a line-sealing function worked in the embodiment 3, because the height of the sealing material was changed. In Comparative Example 1 and Comparative Example 2, the maximum sealing pressure value is lower than the result in the embodiment 2 providing the line-sealing structure, because of a face-sealing structure adapted to provide the sealing by the bonded faces of the metallic pressed plate and the resinous frame member plate. Further, in the cell made using the separator produced in the embodiment 4, the maximum sealing pressure was raised up to 550 kPa. The reason is considered to be that in the embodiment 3, the sealing between the sealing frame and the electrolyte membrane utilized the elasticity and adhesion of the electrolyte membrane, whereas in the case where the separator produced in the embodiment 4 was used, the sealing characteristics between the sealing frame and the electrolyte membrane was enhanced, because the linear sealing material was formed on each of the surface and the back of PPS in the sealing frame.

TABLE 2

| | Maximum sealing |
|---|---|
| | pressure (kPa) |
| Embodiment 2 | 200 |
| Embodiment 3 | 350 |
| Embodiment 4 | 550 |
| Comparative Example 1 | 185 |
| Comparative Example 2 | 180 |

Pressure gages were mounted in a cell outlet and inlet of a gas supply line for each of the simplex cells made using the separator produced in the embodiment 3 and the embodiment 5, and a power-generating test was carried out by supplying a modified test gas having a hydrogen concentration of 50% by volume as an anode gas and air as a cathode gas to the simplex cell in such a manner that they were passed through a bubbler having a temperature of 60° C. to add a predetermined amount of water vapor, and by flowing electric current having a current density set at 0.3 A/cm² by an electronic loading device. In this case, an amount of gas consumed for the power generation based on an amount of gas supplied was defined as a utilization rate. The hydrogen utilization rate was set at 0.8, while the oxygen utilization rate is set at 0.5, and corresponding amounts of the gases were supplied.

Using pressure values indicated by pressure gages in the cell outlet and inlet in the cathode gas line at the time when the voltage of the cell was stabilized, a difference between “pressure in the cell inlet” and “pressure in the cell outlet” is defined as a cathode pressure loss. The cathode pressure losses of the simplex cells using the separators produced in Example 3 and Example 5 are given in Table 3. As a result, the cathode pressure loss of the simplex cell using the separators produced in the embodiment 3 was 5.5 kPa, while the cathode pressure loss of the cell using the separators produced in the embodiment 5 was 3.0 kPa. The reason is considered to be that because the hardness of the sealing material using the separator produced in the embodiment 5 was 60 degree, the amount of sealing material deformed is larger relative to the clamping pressure of the cell, thereby causing the deformation of the gas channel formed by the metallic pressed plate and the sealing frame, resulting in a decrease in sectional area of the channel to provide an increase in resistance to the flowing of the gas. On the other hand, because the material having a hardness of 70 degree was used particularly for the gas channel portion of the sealing frame used in the embodiment 5, the relative deformation was smaller and thus, the increase in resistance of the gas channel could be suppressed.

TABLE 3

| | Value of cathode |
|---|---|
| | pressure loss (kPa) |
| Embodiment 3 | 5.5 |
| Embodiment 5 | 3.0 |

The above-described experiment was carried out for the case where the hydrogen-containing gas was used as the fuel fluid, but even if for example, methanol capable of electrochemically generating a power is used, the separator according to the present invention is effective.

The separator according to the present invention is comprised of the single metal plate, the resinous frame member and the sealing material and hence, is convenient in respect of the material cost. In addition, the separator is easy to fabricate, because the gas channel is formed without recourse to the machining and the injection molding.

It should be further understood by those skilled in the art that although the foregoing description has been made on embodiments of the invention, the invention is not limited thereto and various changes and modifications may be made without departing from the spirit of the invention and the scope of the appended claims.

1. A separator for a fuel cell, comprising a metallic pressed plate, a resinous frame member, and a sealing frame having a sealing material integrated therewith, wherein a gas channel is provided for introducing a gas required for an electrochemical reaction from a manifold adapted to form a communication bore upon the construction of a fuel cell to an electrode surface, said gas channel being formed by said metallic pressed plate, said sealing material and said resinous frame member.

2. A separator for a fuel cell according to claim 1, wherein a sidewall of the gas channel for introducing the gas required for the electrochemical reaction from the manifold to the electrode surface is formed by said sealing material.

3. A separator for a fuel cell according to claim 1, wherein a channel for permitting the flowing of the gas to the electrode surface of the fuel cell is formed in said metallic pressed plate by a pressing.

4. A separator for a fuel cell according to claim 1, wherein said sealing material is formed of an elastomer.

5. A separator for a fuel cell according to claim 1, wherein said resinous frame member is provided with the manifold and a bore in which an electrode portion is accommodated.

6. A separator for a fuel cell according to claim 1, wherein at least a surface layer of said metallic pressed plate is formed of titanium or a stainless steel.

7. A separator for a fuel cell according to claim 1, wherein said sealing material integrated with the resinous frame member has different heights from a resinous surface within said sealing frame.

8. A separator for a fuel cell according to claim 1, wherein said sealing material is formed on a surface and a back of said resinous frame member.

9. A separator for a fuel cell according to claim 1, wherein said sealing material has different hardness within said sealing frame.

10. A fuel cell having a structure in which an anode and a cathode are piled on opposite sides of an electrolyte membrane formed of a polymer ion-exchange membrane, respectively, and the resulting assembly is sandwiched from opposite sides by separators, wherein said separator is comprised of a metallic pressed plate, a resinous frame member, and a sealing frame having a sealing material integrated therewith, and a gas channel for introducing a gas required for an electrochemical reaction from a manifold forming a communication bore upon the construction of a fuel cell to an electrode surface is formed by said metallic pressed plate, said sealing material and said resinous frame member.

11. A fuel cell according to claim 10, wherein said fuel cell includes an anode diffusion layer or a cathode diffusion layer between said anode or said cathode and said separator.

12. A fuel cell according to claim 10, wherein a sidewall of the gas channel for introducing the gas required for the electrochemical reaction from said manifold to the electrode is formed by said sealing material.

13. A fuel cell according to claim 10, wherein a channel for permitting the flowing of the gas to the electrode is formed in said metallic pressed plate by a pressing.

14. A fuel cell according to claim 10, wherein said sealing material is formed of an elastomer.

15. A fuel cell according to claim 10, wherein said resinous frame member is provided with the manifold and a bore for accommodation of the electrode.

16. A fuel cell according to claim 10, wherein at least a surface layer of said metallic pressed plate is formed of titanium or a stainless steel.

17. A fuel cell according to claim 10, wherein said sealing material integrated with the resinous frame member has different heights from a resinous surface within said sealing frame.

18. A separator for a fuel cell according to claim 10, wherein said sealing material is formed on a surface and a back of said resinous frame member.

19. A separator for a fuel cell according to claim 1, wherein said sealing material integrated with said resinous frame member has different hardness within said sealing frame.
